(19) United States
(12) Patent Application Publication
(10) Pub. No.: US 2005/0101313 A1
(43) Pub. Date: May 12, 2005

(54) Method and apparatus for communicating phone with radio services and the like

(76) Inventors: Bart D. Stanco, Fair Field, CT (US); Shlomo Shur, Fairfield, CT (US); Andrew Kontomerkos, Trumbull, CT (US)

Correspondence Address: BACHMAN & LAPOINTE, P.C., 900 CHAPEL STREET, SUITE 1201, NEW HAVEN, CT, 06510, US

(21) Appl. No.: 10/916,673

(22) Filed: Aug. 11, 2004

Related U.S. Application Data
(60) Provisional application No. 60/494,141, filed on Aug. 11, 2003.

(51) Int. Cl. H04M 1/66; H04M 1/68

(52) U.S. Cl. 455/422.1; 455/411

(57) ABSTRACT

A method for communicating a telephone with radio, home computer or network based services, including the steps of communicating the telephone with a gateway to radio, home computer or network based services; validating access of the telephone with the gateway; and providing the telephone with a list of available services.

### BACKGROUND OF THE INVENTION

The invention relates to phone communications and more particularly to a method and apparatus for communicating a phone with radio stations and the like. The goal is to allow quick and easy access to radio stations from a phone.

Phones are rapidly becoming a part of everyday life functions and, used properly, can greatly enhance and facilitate such functions. Often, phones are the only device available to an individual for accessing or communicating with other individuals and/or sources.

Despite numerous new and popular media sources, radio continues to be an extremely popular source of news, entertainment and the like. Unfortunately, radio signals when accessed conventionally are limited to certain areas and can be subject to various interference and/or interruption with the signal.

It is the object of the invention to both enhance the usefulness of phone devices and also to enhance access to radio as may be desired.

It is a further object of the invention to provide secure access and control via a telephone to various resources such as: access to home computer and network, access to network based services or combinations of end user owned and third party resources. The access and control may be for the bridging of radio broadcast (live or replayed) or to access and control other computer or network resources. Another example would be to provide caller access to their electronic based calendar and have their daily appointment spoken back to the caller. The caller can access and control applications and data on their home, business or other remote computer and or networks via a phone.

### SUMMARY OF THE INVENTION

According to the invention, the foregoing object has been readily attained. According to the invention, phone devices are provided access to various radio services in a system and method wherein various ways are implemented for allowing phone user access to the radio services, various methods of allowing selection of radio service are provided, and automatic functionality can be provided for initiating contact to the phone from the radio source or server, for example to allow scheduled play of a radio station, or the like. The caller can also access and control various features, for example, the caller can choose which radio station to listen to. The caller can also access and control computer and network based resources such as data or control functions.

### DETAILED DESCRIPTION

In use, a person connects, (for example by dialing a number, selecting a pre-programmed feature key or voice command on the phone, or the like), to the radio services from any phone. Specialized hardware and software are used in accordance with the invention.

Specialized software will be used to convert various formats (IP, MP3, VoIP, MIDDI, MPEG, etc.) to transmit over the public telephone networks (cellular, land line, etc.). Specialized software will also allow configuration and control via WEB browser and or computer interface.

The specialized hardware provides call ring and answer detection circuitry, DTMF and DSP circuitry for voice detection and audio transmission. The specialized software and hardware can be active during an entire call to allow the caller to access, control and even record transmission. The recordings can be stored on the caller computer and or network or third party resources. The call control circuitry can be active or disabled. If the caller is using a cellular phone an icon may be displayed, or flashing, to alert the caller that call control and or other features are activated. If the caller is on land line, a tone and/or announcement may be used to alert the caller that call control and/or other features are activated.

Specializing of the hardware and software as set forth above to provide the desired function is well within the skill of a person of ordinary skill in the art.

The radio services application can be provided with functionality to identify the caller in various ways, for example either by automatically identifying who is the caller or by prompting the caller to enter information (such as an identification code, billing information for new subscribers, an offering code and the like). Once identified and connected, the user can select from the available radio services as desired.

It may be desirable to have subscribers sign up to the radio services either via the WEB, a third party agent or by connecting to the radio services, so as to provide for a suitable access code or the like for future use if desired.

Once connected to the radio services, the subscriber can then chose which radio station to listen to. The subscriber can select radio stations, and the server receiving the call is programmed to allow such selection, via any of the following methods.

Single digit or voice commands can be stored and then entered by the user for access to pre-selected radio stations using techniques well known to a person of ordinary skill in the art. The subscriber or a third party agent may configure the pre-selections. The pre-selection configuration can be administered over the WEB or via connection to the radio services server, or can be accomplished in other ways as well.

For example, the subscriber can dial or speak the “call letters” of the radio station, e.g. WCBS.

Another embodiment of the invention involves the automatic connection of the subscriber to pre-configured radio stations, for example based upon the time of day, day of week or an event trigger. This configuration can be set up by the subscriber using the Web, or by phone access, for example by dialing a digit(s) to make selections, by voice command of a programmed button, or browser interaction or via a third party agent to set up radio station selections, time of day alerts, event triggers and the like. The criteria for such automatic connection can also be entered, selected and stored by the subscriber as desired. This aspect of the invention allows such scheduled connection which is to be initiated by the subscriber's phone.

The Radio Services can also originate a connection to the subscriber based upon time of day, day of week or event trigger, or other similar criteria, as described above. A subscriber can either chose while listening for example by dialing a digit(s), voice command of programmed button, or browser interaction or to have an automatic schedule of recording and “on command” play back via dialing a digit(s), voice command of programmed button, or browser interaction of broadcast or event trigged recording. For example a subscriber may choose to have the 2 prior traffic reports recorded before they leave for work. And then chose to play them as they enter their car to determine the best route to drive to work.

The radio services can be delivered via a computer based server that can be and/or is connected to any one or more of the following: connect to radio feeds, air wave reception, internet connected, acoustically coupled, bridged to gateway server for sources of radio station and the like.

The computer based radio services server can itself be the authentication server or the process of authentication can be delegated to another server or computer based service. A web server component is also part of the radio services. The web server component has several sub functions that can be used, or which may be invoked only as necessary. The web services component provides a registration process, radio station selection configuration for one or more dialed digit access, alert status configuration tables (time of day, day of week, event trigger, etc). The web services component provides a data transfer mechanism that can be a billing system or transfer billing information to a third party. The computer based access and control of radio computer and or network services server can itself be the web server or the process of the web server can be delegated to another server or computer based service.

It should be appreciated that the present invention advantageously provides communication of a phone and radio signals as desired, with the following advantageous features:
1) connecting of a phone (cell, land line, sea, or any device that can connect to the public voice network) to radio stations, computer and or network;
2) automatic and/or manual identification of the subscriber;
3) a radio services server that can be and/or is connected through any of the following: connect to radio feeds, air wave reception, internet connected, acoustically coupled, bridged to gateway server for sources of radio station and the like;
4) single digit access to radio, computer and or network services;
5) speech recognition access to radio, computer and or network services;
6) dial up call access to radio, computer and or network services;
7) event trigger access;
8) code based access;
9) alert and or automatic calls to subscriber based on profile such as time of day, day or week, or event; and
10) web based self-service access for configuration, provisioning and or billing.

It should be appreciated that the present invention therefore advantageously provides a phone user with easy and secure access to radio and computer and or network services through an identification process and process for selection of the desired radio services which greatly expand the conventional uses of the phone and facilitate enjoyment or other use of radio services as desired.

It should also be understood that the invention is not limited to the illustrations described and shown herein, which are deemed to be merely illustrative of the best modes of carrying out the invention, and which are susceptible of modification of form, size, and arrangement of parts and details of operation. The invention rather is intended to encompass all such modifications which are within its spirit and scope.

1. A method for communicating a telephone with radio, home computer or network based services, comprising the steps of:
communicating the telephone with a gateway to radio, home computer or network based services;
validating access of the telephone with the gateway; and
providing the telephone with a list of available services.
